(19) United States
(12) Patent Application Publication
(10) Pub. No.: US 2007/0080051 A1
(43) Pub. Date: Apr. 12, 2007

(54) Button structure applicable to a touch unit of an electronic device

(75) Inventors: Michael Yang, Taipei (TW); Gen-Cai Zhang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/271,106

(22) Filed: Nov. 10, 2005

(30) Foreign Application Priority Data
Oct. 11, 2005 (TW) 094217500

(51) Int. Cl. H01H 13/14

(52) U.S. Cl. 200/341

(57) ABSTRACT

A button structure applicable to a touch unit of an electronic device is disclosed. The button structure includes a main body for touching the touch unit, a connecting portion installed on both sides of the main body and having a curved structure, and a fixing portion connected to the connecting portion for fixing the button structure to the electronic device. Under torsion force provided by the connecting portion, the main body is able to touch the touch unit evenly, so as to solve the problems of the prior art.

### BACKGROUND OF THE INVENTION

1. Field of the Invention

The present invention relates to a button structure, and more particularly, to a button structure applicable to a touch unit of an electronic device.

2. Description of Related Art

In recent years, a modern electronic device is designed to comprise a button device for controlling a variety of functions of the electronic device. For example, a personal computer (PC) is installed with a power button for controlling a power-on/power-off function of the PC, a cellular phone is installed with a plurality of key buttons for providing a dialing and a selection functions, and a remote control of an electronic appliance, such as a TV and an air conditioner, is used to control the electronic appliance with a plurality of buttons installed on the remote control.

Take the PC as an example to illustrate how the power button is used to power-on/power-off the PC. A control panel is installed neighboring the power button, and the power button comprises a spring. When pressed, the power button is in contact with the control panel; On the other hand, the spring drives the power button back to an original position when the power button is released. However, an assembly structure of the spring and the power button is complicated, so such a button structure costs high and is not an ideal design.

In order to solve the above problem, a button manufacture presented a cantilever-typed button structure 1. Please refer to FIG. 1A, which is a front view of the cantilever-typed button structure 1 according to the prior art. The button structure 1 comprises a main body 10 and two cantilevers 12 installed on both sides of the main body 10 for supporting the main body 10. Please refer to FIG. 1B, which is a top view of the button structure 1. When a user presses a force face 100 of the main body 10 to move the main body 10, a contact face 102 of the main body 10 is controlled to be in contact with a touch unit (not shown) of an electronic device, the touch unit being used to control the electronic device.

However, since both of the cantilevers 12 is in the shape of a strip, a strip-shaped cantilever providing too less a spring force, the main body 10 is not full of elasticity. Moreover, such a button structure fails to provide a resolving power such as torsion force, this limiting an effective force region of the button structure 1. In consequence, if the user presses the main body 10 on a non-effective force region of the force face 100 by pressing a top side or a bottom side of the force face 100, the touch face 102 will not touch the touch unit, and touch unit can not control the electronic device. Therefore, since the force face 100 has too small an effective area, the button structure 1 is not reliable. Moreover, since the cantilevers 12 are both in the shape of a strip, the button structure 1 is easily lack of elasticity or even damaged after a long period of use.

Please refer to FIG. 2A, which is a front view of another button structure according to the prior art. In contrast to the button structure 1 shown in FIG. 1A, the button structure shown in FIG. 2A comprises a main body 20a and a plurality of cantilevers 22a installed symmetrically on both sides of the main body 20a. However, since the cantilevers 22a shown in FIG. 2A are all still in the shape of a strip, the button structure shown in FIG. 2A cannot overcome the drawback of unbalanced forcing on the button structure 1 shown in FIG. 1A.

Please refer to FIG. 2B, which is a third button structure according to the prior art. In contrast to the button structure 1 shown in FIG. 1A and FIG. 1B, the button structure shown in FIG. 2B comprises a main body 20b and a plurality of cantilevers 22b, all of which are installed on a side of the main body 20b. When the button structure shown in FIG. 2B is used to press the main body 20b, a force on the side of the main body 20b where the cantilevers 22b are installed is greater than another force on the other side of the main body 20b, and the main body 20b is moved up and down only. Such the button structure is hard to manipulate.

Since the prior art has the disadvantages of poor manipulation, complicated structure, unbalance forcing and fragile structure, it becomes an important issue to develop a robust button structure having the advantages of well manipulation, simple structure.

### SUMMARY OF THE INVENTION

In the light of forgoing drawbacks, an objective of the present invention is to provide a balanced forcing button structure.

Another objective of the present invention is to provide a button structure of a simple structure.

Still another objective of the present invention is to provide a button structure easy to manipulate.

Still another objective of the present invention is to provide a button structure of a robust structure.

Still another objective of the present invention is to provide a button structure having design flexibility.

In order to achieve the above objectives, the present invention provides a button structure, which includes a main body for touching the touch unit, a connecting portion installed on both sides of the main body and having a curved structure, and a fixing portion connected to the connecting portion for fixing the button structure to the electronic device.

Preferably, the main body includes a force face for an external force to be pressed on, and a touch face opposite to the force face for touching a top face of the touch unit. The main body is in the shape of one selected from the group consisting of a strip, a square, a circle and an ellipse. The connecting portion is integrated with the main body. According to one embodiment of the present invention, the curved-structured connecting portion has only one turning point. According to another embodiment of the present invention, the curved-structured connecting portion is in a structure of a plurality of turning points, and is in the shape of one selected from the group consisting of characters “U”, “V”, “W”, “M”, “S” and “Z”. The fixing portion is a frame.

In contrast to the prior art, the button structure of the present invention increases an effective area of the force face of the main body by implementing the curved-structured connecting portion on both sides of the main body, and the button structure performs a well pressing effect. Therefore, the drawbacks of poor manipulation and unbalanced forcing are solved. Furthermore, through the use of the button structure of the present invention, drawback of the complicated assembly structure of the spring and the button structure of the prior art can be solved, and the button structure becomes more robust. Moreover, the present invention presents a variety of embodiments, and is more flexible in design than the prior art.

Therefore, the button structure of the present invention provides a variety of effects, such as balanced force, well manipulation, simple structure and robust structure, so as to overcomes the drawbacks of the prior art and promote the design flexibility of a button structure product.

### BRIEF DESCRIPTION OF THE DRAWINGS

The present invention can be more fully understood by reading the following detailed description of the preferred embodiments, with reference made to the accompanying drawings, wherein:

FIG. 1A is a front view of a button structure according to the prior art;

FIG. 1B is a top view of the button structure shown in FIG. 1A;

FIG. 2A is a front view of another button structure according to the prior art;

FIG. 2B is a front view of a third button structure according to the prior art;

FIG. 3A is a front view of a button structure of a first embodiment according to the present invention;

FIG. 3B is a top view of the button structure shown in FIG. 3A;

FIG. 4A is a front view of the button structure shown in FIG. 3A when applied by an external force;

FIG. 4B is a cross-sectional diagram of the button structure along a line A-A′ shown in FIG. 4A;

FIG. 5 is a schematic diagram of a button structure of a second embodiment according to the present invention; and

FIGS. 6A to 6D are schematic diagrams of four button structures according to the present invention.

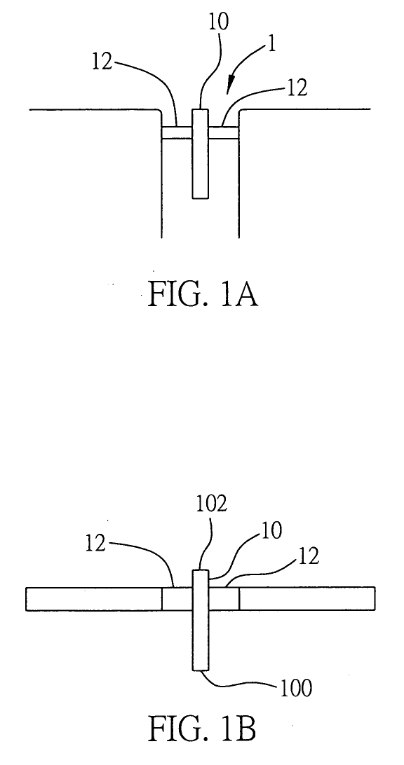

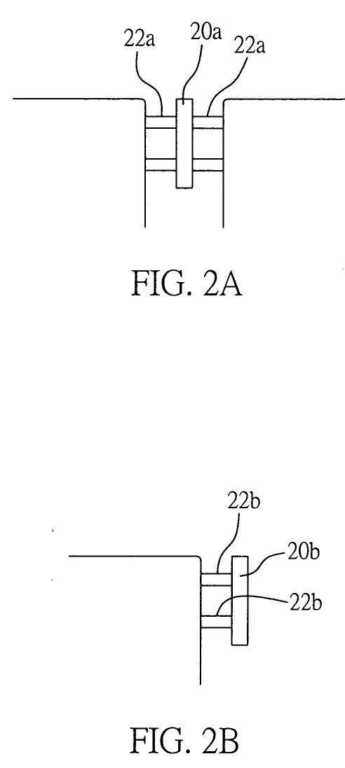

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

The First Embodiment

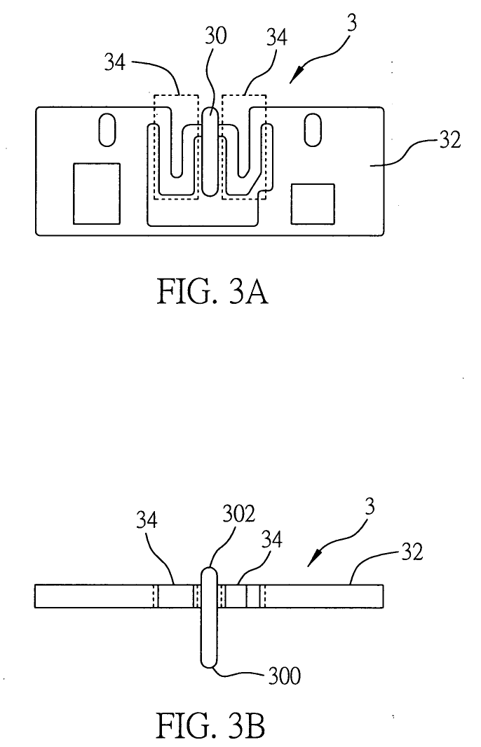

FIGS. 3A, 3B are drawn in accordance with a button structure of a first embodiment according to the present invention, the button structure able to be applied to an electronic device. It should be noted that, according to the first embodiment, a button structure 3 is used to touch a touch unit (not shown) of the electronic device. Since the touch unit pertains to a conventional design of an ordinary electronic device, and has a structure and an operating principle known by those skilled in the art, further drawing and description of the touch unit hereby omitted. The button structures described in the following embodiments are examples to, but not limited to, describe the present invention.

Please refer to FIGS. 3A and 3B. FIG. 3A is a front view of the button structure 3 of the first embodiment according to the present invention. FIG. 3B is a top view of the button structure 3. The button structure 3 comprises a main body 30, a fixing portion 32 and a connecting portion 34.

The main body 30 is installed for touching the touch unit, and comprising a force face 300 for an external force to be pressed on, and a touch face 302 opposite to the force face 300 for touching a top face of the touch unit. According to the first embodiment, the main body 30 is in the shape of one selected from the group consisting of a strip, a square, a circle, an ellipse and any other appropriate shape.

The fixing portion 32 is connected to the connecting portion 34 for fixing the button structure 3 to the electronic device. According to the first embodiment, the fixing portion 32 is for example a frame. As known by those skilled in the art, any structure can be applied to the present invention as long as it is capable of connecting the connecting portion 34 and fixing the button structure 3 to the electronic device. The fixing portion 32 has a structure changed according to a structure of the electronic device. The fixing portion 32 disclosed in the first embodiment is merely an example, and cannot be used to limit the present invention.

The connecting portion 34 has a curved structure, and is installed on both sides of the main body 30 and connected to the fixing portion 32. According to the first embodiment, the connecting portion 34 is made of elastic material and is flexible, and is integrated with, but is not limited to, the main body 30 and is outward extended from the opposite sides of the main body 30. The curved-structured connecting portion 34 is in the shape of a character “U”.

When the button structure of the first embodiment is in use, since the connecting portion 34 has the curved structured, a press force applied on the main body 30 is divided into an elastic force and a torsion force, which enabling the main body 30 to receive balanced forces. Preferably, the connecting portion 34 can be symmetrically installed on the main body 30, and a direction of a resultant due to the elastic force and the torsion force is therefore parallel to a moving direction of the main body 30, so as to further balance the applied force and improve the manipulation of the button structure 3.

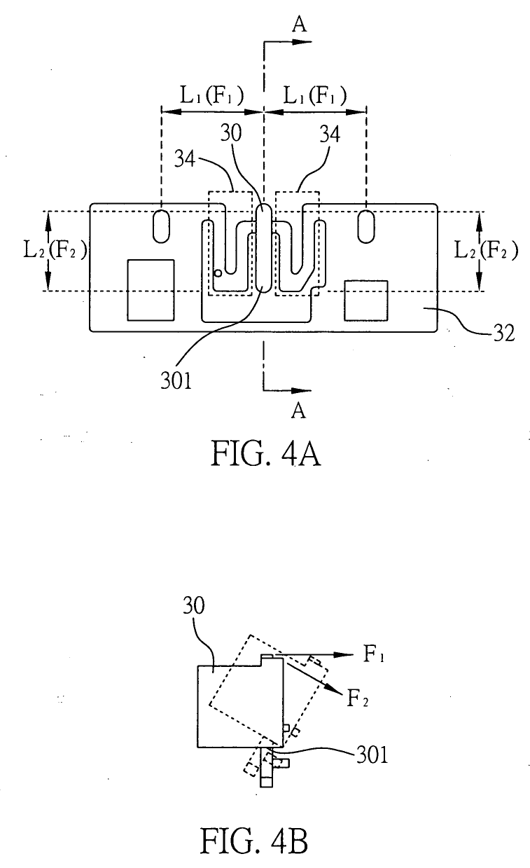

Please refer to FIGS. 4A and 4B. FIG. 4A is a front view of the button structure 3 when applied by an external force F (press force), and FIG. 4B is a cross-sectional diagram of the button structure 3 along a line A-A′ shown in FIG. 4A;

As shown in FIG. 4A, the external force F applied on the main body 30 is equal to an elastic force F1 applied on the main body 30 added by a torsion force F2 applied on the main body 30. The elastic force F1 is affected by a variety of factors, such as thickness of the main body 30 and the connecting portion 34 and a length L1 of a transmission arm between the main body 30 and the connecting portion 34; The torsion force is affected by a variety of factors, such as the thickness of the main body 30 and the connecting portion 34 and a length L2 of an arm between a force center and a transmission pivot of the main body 30. Preferably, the main body 30, and the connecting portion 34 as well, are installed symmetrically. Therefore, the direction of the resultant force provided by the arms L1 located on both sides of the main body 30 is parallel to a moving direction of the elastic force F1 (as shown in FIG. 4B), enabling the main body 30 to touch a member which needs an external force to be applied to. According to the first embodiment, the torsion force F2 has a variable moving direction. At a moment when the main body 30 is pressed, the torsion force F2 has a moving direction the same as the moving direction of the elastic force F1; Then, the main body 30 moves clockwise around a circle having a center of a pivot 301, the torsion force F2 is changed to move clockwise, and the torsion force F2 has a moving track tangent to the elastic force F1 as long as the main body 30 is moving.

Take the main body 30 when moving a distance L as an example. An external force is needed to apply a work Q on the main body 30. The work Q is equal to a first work Q1 multiplied by a second work Q2, where the first work Q1 is equal to the elastic force F1 multiplied by a first distance L1 between the force point of the main body 30 and an end of the connecting portion 34 where the elastic force F1 is applied, and the second work Q1 is equal to the torsion force F2 multiplied by a second distance L2 between the main body 30 and a torsion arm applied by the torsion force F2. Apparently, if the work Q applied to the main body 30 is constant, the longer the distances L1 and L2, the smaller a sum of the elastic force F1 and the torsion force F2 becomes.

In contrast to the prior art, when the button structure 3 of the first embodiment is pressed by an external force, the external force is applied on the main body 30, and the connecting portion 34 is deformed resulting from the external force applied on the main body 30. Therefore, the main body 30 is in balance due to the resultant force of the elastic force F1 and the torsion force F2, and performs better manipulation and press effect.

Moreover, compared with the prior art, the present invention simplify a button structure, and the simplified button structure still has a robust structure and well elasticity even after a long period of use.

The Second Embodiment:

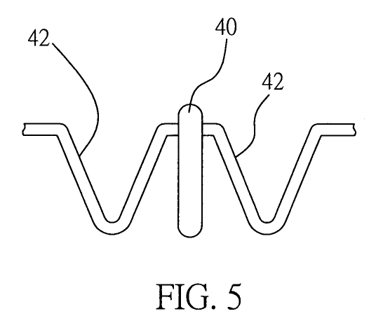

Pleaser refer to FIG. 5, which is a partial diagram of a button structure of a second embodiment according to the present invention. In the second embodiment, components having functions similar to those of the components in the first embodiment are indicated by identical symbols, and further description of these similar components are omitted for simplicity.

The difference between second embodiment and the first embodiment is the connecting portion 34 has a curved structure in a variety of shapes.

The connecting portion 34 according to the first embodiment has a curved structure in the shape of a character “U”, and is installed symmetrically on the main body 30. According to the second embodiment, as shown in FIG. 5, the connecting portion 34 has another curved structure in the shape of a character “V”, and also provides a touch manipulation better than that of the prior art.

It should be noted that the connecting portions 34 in the first and second embodiments are designed to have the curved structure having only one turning point. However, those skilled in the art know the connecting portion 34 can have other curved structure, and the curved-structured connecting portion 34 can have multiple turning points.

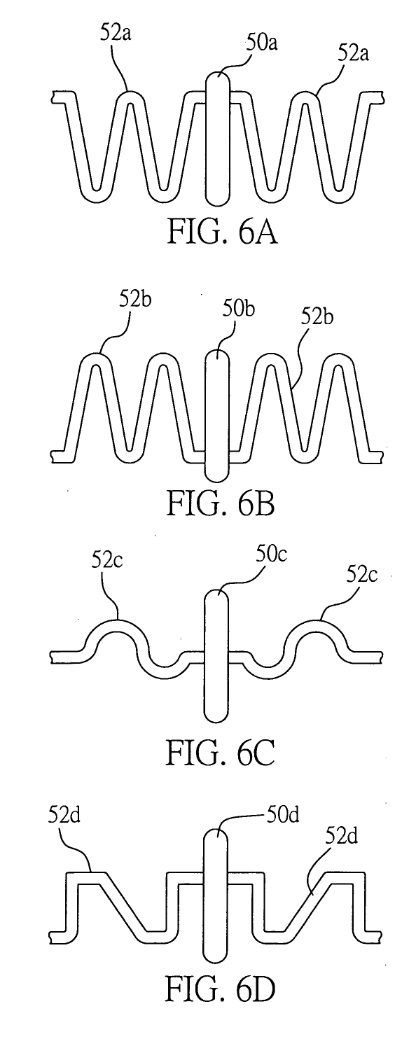

Please refer to FIGS. 6A to 6D, which are schematic diagrams of four button structures according to the present invention. As shown in FIG. 6A, a curved-structured connecting portion 52a is in the shape of a character “W”, and is symmetrically installed on both sides of a main body 50a; As shown in FIG. 6B, a curved-structured connecting portion 52b is in the shape of a character “M”, and is symmetrically installed on both sides of a main body 50b; As shown in FIG. 6C, a curved-structured connecting portion 52c is in the shape of a character “S”, and is symmetrically installed on both sides of a main body 50c; As shown in FIG. 6D, a curved-structured connecting portion 52d is in the shape of a character “Z”, and is symmetrically installed on both sides of a main body 50d.

In other words, as long as the resultant force due to the elastic force F1 and the torsion force F2 applied on the main body 30 balances the button structure 3, the shaped of the curved-structured connecting portion 34 is not limited to the above-mentioned shapes. Therefore, the button structure 3 of the present invention has well design flexibility.

In contrast to the prior art, the button structure of the present invention increases an effective area of the force face of the main body by implementing the curved-structured connecting portion on both sides of the main body, and the button structure performs a well pressing effect. Therefore, the drawbacks of poor manipulation and unbalanced forcing are solved. Furthermore, through the use of the button structure of the present invention, drawback of the complicated assembly structure of the spring and the button structure of the prior art can be solved, and the button structure becomes more robust. Moreover, the present invention presents a variety of embodiments, and is more flexible in design than the prior art.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

1. A button structure applicable to a touch unit of an electronic device, the button structure comprising:
a main body for touching the touch unit;
a connecting portion installed on both sides of the main body and having a curved structure having only one turning point; and
a fixing portion connected to the connecting portion for fixing the button structure to the electronic device.

2. The button device of claim 1, wherein the main body comprises:
a force face for an external force to be pressed on; and
a touch face opposite to the force face for touching a top face of the touch unit.

3. The button device of claim 1, wherein the main body is in the shape of one selected from the group consisting of a strip, a square, a circle and an ellipse.

4. The button device of claim 1, wherein the connecting portion is integrated with the main body.

5-6. (canceled)

7. The button device of claim 1, wherein the curved-structured connecting portion is in the shape of one selected from the group consisting of characters “U” and “V”.

8. The button device of claim 1, wherein the fixing portion is a frame.
